(19) United States
(12) Patent Application Publication
(10) Pub. No.: US 2011/0308307 A1
(43) Pub. Date: Dec. 22, 2011

(54) Test machine

(76) Inventors: Dean Schneider, Washington, MI (US); Imtiaz Ali, Lathrup Village, MI (US)

(21) Appl. No.: 12/802,932

(22) Filed: Jun. 17, 2010

(51) Int. Cl. G01M 15/06

(52) U.S. Cl. 73/114.26

(57) ABSTRACT

A test machine comprising a driver (10) connected to an input shaft (42), the input shaft (42) having an axis of rotation (CL1), an output shaft (43) having an axis of rotation (CL2), a driveshaft (40) connected between the input shaft and the output shaft by a universal joint (41) and a universal joint (410), a rotational angle (γ) for the first universal joint (41) and a rotational angle (γ₂) for the second universal joint (410) are in-phase, and the input shaft axis of rotation (CL1) and the output shaft axis of rotation (CL2) are parallel to each other and are offset from each other such that the output shaft speed varies sinusoidally with respect to the input shaft speed.

### FIELD OF THE INVENTION

The invention relates to a test machine, and more particularly, to a test machine having an input shaft that is offset from an output shaft in order to effect a sinusoidal variation in the output shaft speed.

### BACKGROUND OF THE INVENTION

It is known that an internal combustion engine produces a sinusoidal vibration on the ends of the crankshaft. Typical test requirements for components affected by this internal combustion crankshaft vibration require testing be performed on an actual engine, for example, front end accessory drives. Testing on an actual engine can be limited in the hours of operation and requires regular frequent maintenance of the engine during the test since the test can run into the hundreds of hours.

Representative of the art is U.S. Pat. No. 4,283,957 (1981) to Zobrist et al. which discloses an exciter for applying a dynamic torsional force to a rotating structure, such as to the shaft of a turbine generator, the axle of a vehicle, or the like, during mechanical testing to determine the mechanical response characteristics, natural modes of vibration, fatigue life, etc., of the structure. The exciter includes a rotary hydraulic actuator having a housing secured to the structure to be tested and a driveshaft which is rotatable relative to the housing as well as an inertial mass mounted on the driveshaft. The exciter also includes a hydraulic power supply for the actuator and an electrohydraulic means comprising a torque setpoint circuit for producing a torque command signal to set the desired amplitude and frequency of oscillation of the inertial mass, a position setpoint circuit for producing a position command signal to set the midpoint of the arc through which the inertial mass oscillates, means for producing a torque feedback signal dependent on the actual dynamic torsional force produced by the oscillating inertial mass, means for producing a position feedback signal dependent on the average angular position of the inertial mass relative to the structure as the inertial mass oscillates and a controller responsive to the command and feedback signals for energizing a servovalve that controls the supply of pressurized fluid to the actuator. The actuator oscillates the inertial mass relative to the structure to be tested in order to produce a controlled dynamic torsional force on the rotating structure.

What is needed is a test machine having an input shaft that is offset from an output shaft in order to effect a sinusoidal variation in the output shaft speed. The present invention meets this need.

### SUMMARY OF THE INVENTION

The primary aspect of the invention is a test machine having an input shaft that is offset from an output shaft in order to effect a sinusoidal variation in the output speed.

Other aspects of the invention will be pointed out or made obvious by the following description of the invention and the accompanying drawings.

The invention comprises a test machine comprising a driver (10) connected to an input shaft (42), the input shaft (42) having an axis of rotation (CL1), an output shaft (43) having an axis of rotation (CL2), a driveshaft (40) connected between the input shaft and the output shaft by a universal joint (41) and a universal joint (410), a rotational angle (γ) for the first universal joint (41) and a rotational angle (γ₂) for the second universal joint (410) are in-phase, and the input shaft axis of rotation (CL1) and the output shaft axis of rotation (CL2) are parallel to each other and are offset from each other such that the output shaft speed varies sinusoidally with respect to the input shaft speed.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a plan view of the test machine.

FIG. 2 is a perspective view of the test machine.

FIG. 3 is a detail of the driveshaft.

FIG. 4 is a schematic of the input shaft rotational angles.

FIG. 5 is a graph that shows how the output speed fluctuates with a constant input speed for the test machine.

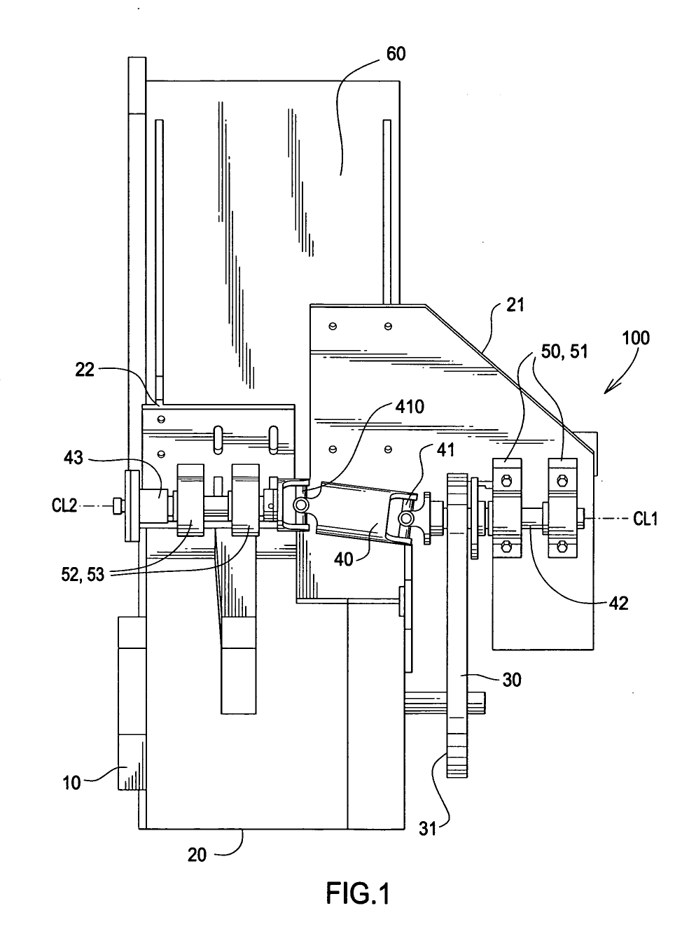

### DETAILED DESCRIPTION OF THE PREFERRED EMBODIMENT

This invention comprises a test machine that simulates an internal combustion engine's crankshaft vibration. This invention allows testing of components subject to crankshaft vibration on an electrically driven test machine that can be controlled with electronic controls and can run 24 hours a day seven days a week without need for human input. It also can allow the test rotational speed to increase while maintaining the appropriate vibration in the system. This increase in rotational speed coupled with the ability to test continuously, and less down time for maintenance allows for dramatically shortened overall test times.

The test machine apparatus consists of a known waterbrake test machine, except that it is modified to drive an output shaft through universal joints. The output shaft and universal joints run at an angle. When universal joints run at angle they have an output speed that oscillates about the input speed in a sinusoidal manner and thus the output speed is not constant velocity.

The test machine comprises an electric motor 10 mounted to a test stand 20. A belt 30 connects the electric motor output to the input shaft 42 through motor output pulley 31 and input pulley 32.

Driveshaft 40 is journalled to the test stand 20 at each end by pillow blocks 50, 51, 52, 53. Pillow blocks 50, 51 are mounted to plate 21. Pillow blocks 52, 53 are mounted to plate 22. Input shaft 42 runs in pillow blocks 50, 51. Output shaft 43 runs in pillow blocks 52, 53. A load or equipment to be tested is attached to output shaft 43. For example, a belt drive accessory system can be connected to output shaft 43. Output shaft 43 is shown with a flange attached to connecting to driven equipment. Plate 22 can be adjusted to achieve a desired crankshaft offset.

Universal joints 41 and 410 are disposed at each end of the driveshaft 40. Universal joints 41 and 410 are known in the art, for example, Dana Spicer U-joints.

Input shaft 42 has an axis of rotation CL1. Output shaft 43 has an axis of rotation CL2. Axis CL1 is offset laterally from axis CL2 in the range from ˜1.0 mm for a driveshaft length of ˜10 cm up to ˜10.0 mm for a driveshaft length of ˜100 cm. The offset may also be characterized as joint angle (β). Of course the offset may be any value depending upon the requirements of the user.

Operation.

A typical drive train drive shaft is configured such that the input and output axis are parallel but offset. The drive train will include two universal joints in series which are rotationally oriented such that the speed fluctuation of the first joint's output is canceled by the output from the second joint. Hence, the overall final output speed is essentially constant regardless of the joint angle at any particular time.

The inventive test machine is configured such that the two universal joints 41 and 410 are rotationally oriented such that the universal joint output speed fluctuations are additive rather than cancelling and the final output speed has a sinusoidal oscillation centered about the input speed.

Through control of the joint angle (β) and input speed ω₁, the test machine output can be controlled to simulate the vibrations produced by an internal combustion engine crankshaft. If greater output speed oscillation is desired, the use of additional universal joints oriented in a like manner and connected in series will have an additive effect on the output speed oscillation.

The variation in output angular velocity for a single universal joint is a funtion of the joint angle and the rotational angle of the input shaft. Specifically for one universal joint the formula is:

$${ω}_{2} = \frac{{ω}_{1} cos β}{1 - {sin}^{2} {βcos}^{2} γ}$$

### Where

ω₁=input velocity

ω₂=output velocity

β=joint angle

γ=rotational angle

For a configuration with two joints the input speed of the second joint in series is the output speed of the first joint.

$${ω}_{3} = \frac{[ \frac{{ω}_{1} cos β}{1 - {sin}^{2} {βcos}^{2} γ} ] cos {β}_{2}}{1 - {sin}^{2} {β}_{2} {cos}^{2} {γ}_{2}}$$

### Where

ω₁=initial input velocity

ω3=output velocity of final drive

β=joint angle joint (41)

β₂=joint angle joint (410)

γ=rotational angle joint (41)

γ₂=rotational angle joint (410)

It is to be noted that the joint angle controls the angular displacement while the input speed controls the magnitude of the speed fluctuations and frequency of vibration.

When configured such that the input and output axis are parallel (β and β₂ are equal) but offset and there are two universal joints in series rotationally oriented such that the speed fluctuation of the first joint output is added to by the second joint, the final output speed varies in a sinusoidal manner. This configuration is such that γ and γ₂ are equal. In a traditional driveshaft configuration γ and γ₂ are rotated relative to each other (offset) by 90 degrees. The 90 degree offset causes the cancellation of output speed fluctuation or vibration.

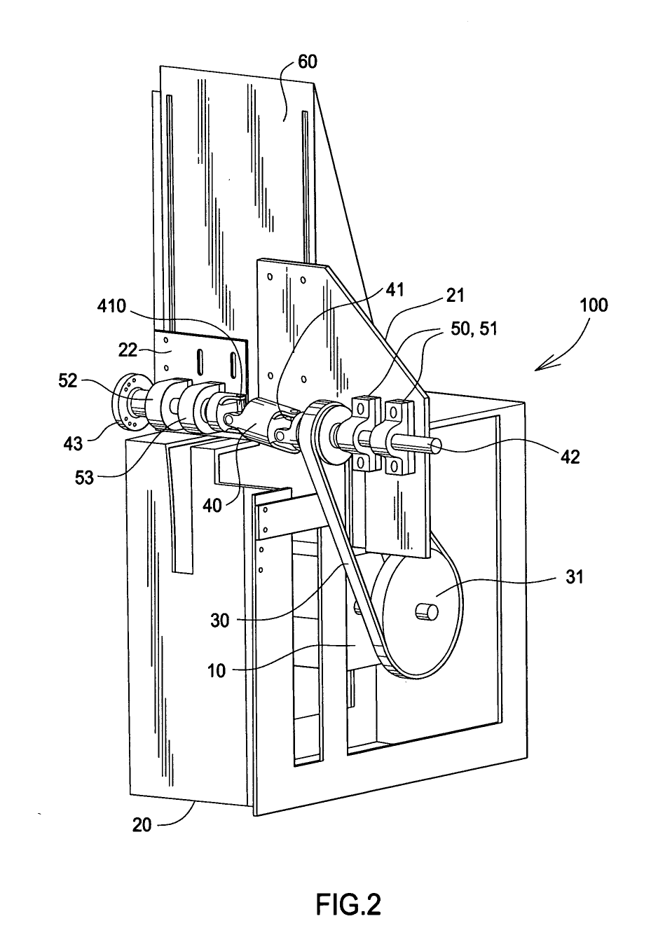

FIG. 2 is a perspective view of the test machine. Plates 21, 22 are adjustably mounted to plate 60 so that a wide variety of belt systems may be tested.

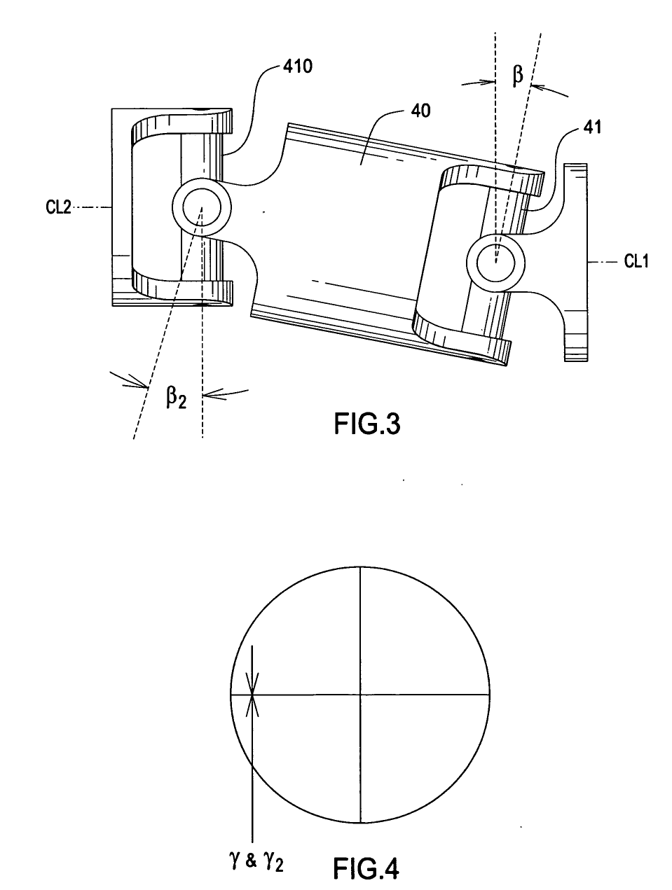

FIG. 3 is a detail of the driveshaft. Each of β=joint angle joint (41) and β₂=joint angle joint (410) are shown. Note that the universal joints 41 and 410 are not out of phase, see FIG. 4. It is the in-phase relationship of the universal joints which gives the sinusoidal speed output from shaft 43.

FIG. 4 is a schematic of the input shaft rotational angles. γ=rotational angle joint (41) and γ₂=rotational angle joint (410) are aligned and are not out of phase. Namely, projecting the rotational angle of the second universal joint (410) into the same plane as the rotational angle of the first universal joint (41) indicates they are rotating in phase, namely γ=γ₂. In the prior art arrangement γ and γ₂ are 90 degrees out of phase.

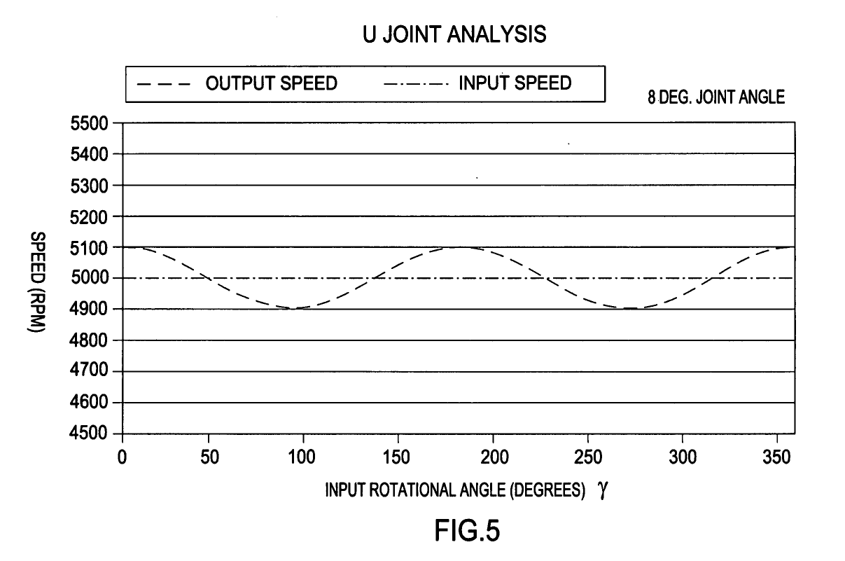

FIG. 5 is a graph that shows how the output speed fluctuates with a constant input speed for the test machine. In this example the solution for ω3 is graphically depicted. The input rotational angle γ is depicted on the x-axis. The input and output speeds are shown on the y-axis. The joint angle (β) is 8 degrees. The input speed is held constant at 5000 RPM. The sinusoidal output speed is shown oscillating between 5100 RPM and 4900 RPM through 360°.

Although a form of the invention has been described herein, it will be obvious to those skilled in the art that variations may be made in the construction and relation of parts without departing from the spirit and scope of the invention described herein.

We claim:

1. A test machine comprising:
a driver (10) connected to an input shaft (42);
the input shaft (42) having an axis of rotation (CL1);
an output shaft (43) having an axis of rotation (CL2);
a driveshaft (40) connected between the input shaft and the output shaft by a universal joint (41) and a universal joint (410);
a rotational angle (γ) for the first universal joint (41) and a rotational angle (γ₂) for the second universal joint (410) are in-phase; and
the input shaft axis of rotation (CL1) and the output shaft axis of rotation (CL2) are parallel to each other and are offset from each other such that the output shaft speed varies sinusoidally with respect to the input shaft speed.

2. The test machine as in claim 1, wherein the driver is connected to the input shaft by a flexible endless member.

3. The test machine as in claim 1, wherein the driver comprises an electric motor.

4. The test machine as in claim 2, wherein the flexible endless member comprises a belt.
